(19) United States
(12) Patent Application Publication
(10) Pub. No.: US 2026/0223176 A1
(43) Pub. Date: Jul. 30, 2026

(54) WIRELESS COMMUNICATION METHOD AND COMMUNICATIONS DEVICE

(71) Applicant: GUANGDONG OPPO MOBILE TELECOMMUNICATIONS CORP., LTD., Dongguan (CN)

(72) Inventors: De ZHU, Dongguan (CN); Liuming LU, Dongguan (CN); Chaoming LUO, Dongguan (CN); Ronghui HOU, Dongguan (CN)

(73) Assignee: GUANGDONG OPPO MOBILE TELECOMMUNICATIONS CORP., LTD., Dongguan (CN)

(21) Appl. No.: 19/574,074

(22) Filed: Mar. 20, 2026

Related U.S. Application Data
(63) Continuation of application No. PCT/CN2023/120593, filed on Sep. 22, 2023.

(51) Int. Cl. H04W 74/0816; H04L 41/122; H04W 8/22; H04W 28/02; H04W 74/00

(52) U.S. Cl. CPC H04W 74/0816; H04L 41/122; H04W 8/22; H04W 28/0278; H04W 74/002

(57) ABSTRACT

Provided are a wireless communication method and a communication device. The method comprises: a first STA receives a first field sent by a first AP, wherein the first field is used for carrying first information, the first information is used for instructing the first AP to share some TXOPs acquired by the first AP to the first STA, the first STA is associated with a second AP, and the first STA is within coverage of a signal sent by the first AP.

### CROSS-REFERENCE TO RELATED APPLICATIONS

This application is a continuation of International Application No. PCT/CN2023/120593, filed on Sep. 22, 2023, the disclosure of which is hereby incorporated by reference in its entirety.

### TECHNICAL FIELD

This application relates to the field of communications technologies, and more specifically, to a wireless communication method and a communications device.

### BACKGROUND

In a related technology, a transmission opportunity (transmission opportunity, TXOP) between devices may be shared. For example, an access point (access point, AP) may allocate a TXOP of the AP to a single station (station, STA) associated with the AP based on a TXOP sharing function. For another example, two APs are in coverage of each other, one AP may share an acquired TXOP to the other AP through coordinated-AP time division multiple access (coordinated-AP time division multiple access, CAP TDMA).

### SUMMARY

This application provides a wireless communication method and a communications device. Various aspects of this application are described below.

According to a first aspect, a wireless communication method is provided, where the method includes: receiving, by a first STA, a first field transmitted by a first AP. The first field is used to carry first information, and the first information is used to indicate that the first AP shares a part of a TXOP acquired by the first AP with the first STA. The first STA is associated with a second AP, and the first STA is in coverage of signal transmission of the first AP.

According to a second aspect, a wireless communication method is provided, where the method includes: transmitting, by a first AP, a first field to a first STA. The first field is used to carry first information, and the first information is used to indicate that the first AP shares a part of a TXOP acquired by the first AP with the first STA. The first STA is associated with a second AP, and the first STA is in coverage of signal transmission of the first AP.

According to a third aspect, a communications device is provided. The communications device is a first STA, and the communications device includes a receiving unit, configured to receive a first field transmitted by a first AP. The first field is used to carry first information, and the first information is used to indicate that the first AP shares a part of a TXOP acquired by the first AP with the first STA. The first STA is associated with a second AP, and the first STA is in coverage of signal transmission of the first AP.

According to a fourth aspect, a communications device is provided. The communications device is a first AP. The communications device includes a transmitting unit, configured to transmit a first field to a first STA. The first field is used to carry first information, and the first information is used to indicate that the first AP shares a part of a TXOP acquired by the first AP with the first STA. The first STA is associated with a second AP, and the first STA is in coverage of signal transmission of the first AP.

According to a fifth aspect, a communications device is provided. The communications device includes a processor and a memory. The memory is configured to store one or more computer programs, and the processor is configured to invoke the computer program in the memory to cause the communications device to perform some or all of the steps of the method according to the first aspect and/or the second aspect.

According to a sixth aspect, an embodiment of this application provides a communications system, and the communications system includes the foregoing communications device. In another possible design, the system may further include another device that interacts with the communications device in the solution provided in embodiments of this application.

According to a seventh aspect, an embodiment of this application provides a computer-readable storage medium. The computer-readable storage medium stores a computer program, and the computer program causes a communications device to perform some or all of the steps in a method according to the foregoing aspects.

According to an eighth aspect, an embodiment of this application provides a computer program product. The computer program product includes a non-transitory computer-readable storage medium storing a computer program, and the computer program is operable to cause a communications device to perform some or all of the steps of a method according to the foregoing aspects. In some implementations, the computer program product may be a software installation package.

According to a ninth aspect, an embodiment of this application provides a chip, where the chip includes a memory and a processor, and the processor may invoke a computer program from the memory and run the computer program, to implement some or all of steps described in a method according to each of the foregoing aspects.

### BRIEF DESCRIPTION OF DRAWINGS

FIG. 1 is a schematic diagram of a wireless communications system to which embodiments of this application are applicable.

FIG. 2 is an example diagram of sharing a TXOP between APs in a CAP TDMA process.

FIG. 3 is an example diagram of a CAP TDMA process.

FIG. 4 is an example diagram of a scenario to which an embodiment of this application is applicable.

FIG. 5 is a schematic flowchart of a wireless communication method according to an embodiment of this application.

FIG. 6 is an example diagram of a virtual basic service set (virtual basic service set, VBSS).

FIG. 7 is an example diagram of a VBSS-based technical solution according to an embodiment of this application.

FIG. 8 is an example diagram of another VBSS-based technical solution according to an embodiment of this application.

FIG. 9 is an example diagram of a virtual association-based technical solution according to an embodiment of this application.

FIG. 10 is an example diagram of another virtual association-based technical solution according to an embodiment of this application.

FIG. 11A is a schematic diagram of a format of a capabilities information field according to an embodiment of this application.

FIG. 11B is an example diagram of a format of an enhancement for extremely high throughput (enhancements for extremely high throughput, EHT) medium access control (medium access control, MAC) capabilities information field according to an embodiment of this application.

FIG. 12 is a schematic diagram of a method according to Embodiment 1 of this application.

FIG. 13 is a schematic diagram of a method according to Embodiment 2 of this application.

FIG. 14 is a schematic diagram of a method according to Embodiment 3 of this application.

FIG. 15 is a schematic structural diagram of a communications device according to an embodiment of this application.

FIG. 16 is a schematic structural diagram of another communications device according to an embodiment of this application.

FIG. 17 is a schematic structural diagram of an apparatus used for communication according to an embodiment of this application.

### DESCRIPTION OF EMBODIMENTS

Technical solutions in this application are described below with reference to the accompanying drawings.

### Communications System

The technical solutions in embodiments of this application may be applied to various communications systems, for example, a wireless local area network (wireless local area networks, WLAN), wireless fidelity (wireless fidelity, WiFi), or another communications system.

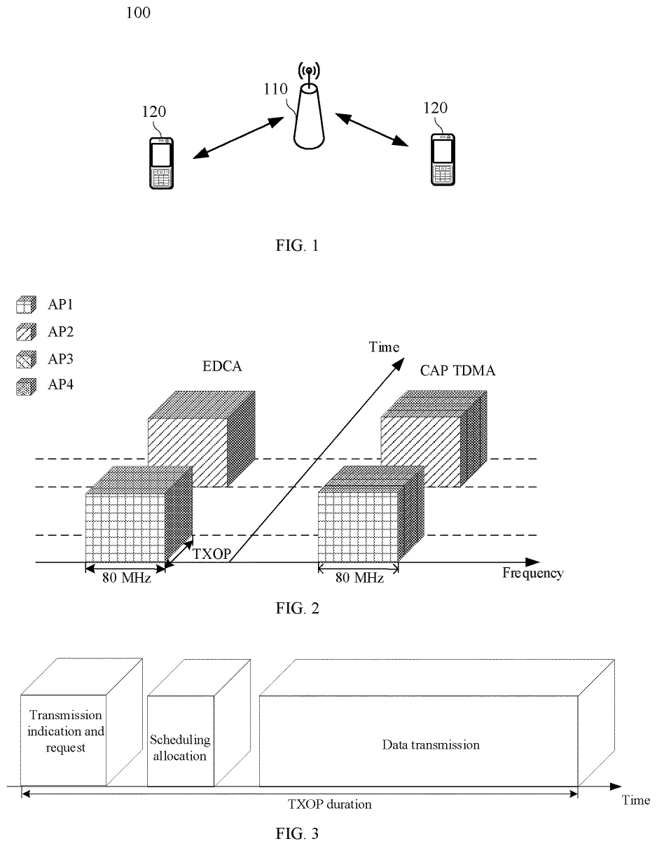

FIG. 1 shows a wireless communications system 100 to which embodiments of this application are applied. The wireless communications system 100 may include an access point 110 and a station 120 that accesses a network by using the access point 110.

In some scenarios, an AP is referred to as an AP STA. That is, in a sense, the AP is also a STA.

In some scenarios, a STA is referred to as a non-AP STA (non-AP STA).

Communication in the communications system 100 may be communication between an AP and a STA, or communication between STAs, or communication between a STA and a peer STA (peer STA). The peer STA may refer to a device that performs peer-to-peer communication with the STA. For example, the peer STA may be an AP, or may be a STA.

An AP is equivalent to a bridge that connects a wired network and a wireless network. A major function of the AP is to connect clients in a wireless network together and then connect the wireless network to an Ethernet. The AP device may be a terminal device (for example, a mobile phone) or a network device (for example, a router) that has a WiFi chip.

It should be understood that a role of a STA in a communications system is not absolute. For example, in some scenarios, when a mobile phone is connected to a router, the mobile phone is a STA; and when the mobile phone serves as a hotspot for another mobile phone, the mobile phone serves as an AP.

The AP and the STA may be devices applied in vehicle-to-everything; internet of things nodes, sensors, and the like in internet of things (internet of things, IoT); intelligent cameras, intelligent remote controls, intelligent water meters, intelligent electricity meters, and the like in smart home; and sensors and the like in smart city.

In some embodiments, both the STA and the AP may support the 802.11be standard. The STA or the AP may alternatively support a plurality of current and future WLAN standards of the 802.11 family, such as 802.11ax, 802.11ac, 802.11n, 802.11g, 802.11b, and 802.11a.

There is one or more links between a station and an access point. In some embodiments, the station and the access point support multi-band communication. For example, communication is simultaneously performed on 2.4 GHz, 5 GHz, 6 GHz, 45 GHz, and 60 GHz bands, or communication is simultaneously performed on different channels of a same frequency band (or different frequency bands), thereby improving communication throughput and/or reliability between devices. Such a device is usually referred to as a multi-band device, or a multi-link device (multi-link device, MLD), and is sometimes also referred to as a multi-link entity or a multi-band entity. The multi-link device may be an access point device, or may be a station device. If the multi-link device is an access point device, the multi-link device includes one or more APs. If the multi-link device is a station device, the multi-link device includes one or more non-AP STAs.

The multi-link device that includes one or more APs may be referred to as an access point multi-link device (access point multi-link device, AP MLD), and the multi-link device that includes one or more non-AP STAs may be referred to as a non-access point multi-link device (non-ap multi-link device, non-AP MLD).

In embodiments of this application, an AP may include a plurality of APs, and a non-AP includes a plurality of STAs. A plurality of links may be formed between the APs in the AP and the STAs in the non-AP, and data communication may be performed between an AP in the AP and a corresponding STA in the non-AP by using a corresponding link.

In embodiments of this application, the STA may be any one of the following that supports the WLAN/WiFi technology: a mobile phone, a tablet computer (Pad), a notebook computer, a palmtop computer, a mobile internet device (mobile internet device, MID), a wearable device, a virtual reality (virtual reality, VR) device, an augmented reality (augmented reality, AR) device, a wireless terminal in industrial control, a wireless terminal in self driving, a wireless terminal in remote medical surgery (remote medical surgery), a wireless terminal in smart grid, a wireless terminal in transportation safety, a wireless terminal in smart city, a wireless terminal in smart home, or the like.

Frequency bands supported in the WLAN technology may include but are not limited to a low frequency band (for example, 2.4 GHz, 5 GHz, or 6 GHz) and a high frequency band (for example, 45 GHz or 60 GHz).

FIG. 1 exemplarily shows one AP and two STAs. Optionally, the communications system 100 may include a plurality of APs and another quantity of STAs. This is not limited in embodiments of this application.

It should be understood that in embodiments of this application, a device having a communication function in a network or a system may be referred to as a communications device. The communications system 100 shown in FIG. 1 is used as an example. A communications device may include the access point 110 and the stations 120 that have a communication function. The access point 110 and the stations 120 may be specific devices described above. Details are not described herein again. The communications device may further include another device in the communications system 100, such as a network controller, a gateway, or another network entity, which is not limited in embodiments of this application.

The AP and the STA may be deployed on land, including being deployed indoors or outdoors, handheld, or vehicle-mounted, may be deployed on a water surface, or may be deployed on a plane, a balloon, or a satellite in the air. In embodiments of this application, a scenario in which the AP and the STA are located is not limited.

It should be understood that all or some of functions of the communications device in this application may alternatively be implemented by software functions running on hardware, or by virtualization functions instantiated on a platform (for example, a cloud platform).

### TXOP Sharing

In some communications systems, an AP may allocate a TXOP of the AP to a single non-AP STA associated with the AP based on a TXOP sharing function. The non-AP STA may implement uplink (uplink, UL) physical layer protocol data unit (physical layer protocol data unit, PPDU) and/or peer-to-peer (peer-to-peer, P2P) frame switching based on a shared TXOP.

The AP may share the TXOP with the non-AP STA by using a multi-user request to send TXOP sharing (multi-user request to send TXOP sharing, MU-RTS TXS) trigger (trigger) frame. For example, a triggered TXOP sharing mode (Triggered TXOP Sharing Mode) subfield of a common information (Common Info) field of a multi-user request to send (multi-user request to send, MU-RTS) trigger frame may be used to represent a TXOP sharing mode. If the triggered TXOP sharing mode subfield is 0, it may indicate that the AP does not use TXOP sharing, that is, the trigger frame is a common MU-RTS trigger frame rather than an MU-RTS TXS trigger frame. If the triggered TXOP sharing mode subfield is 1 or 2, it may indicate that the AP uses TXOP sharing, that is, the trigger frame is an MU-RTS TXS trigger frame.

### Multi-AP TXOP Sharing

In some communications systems, TXOP sharing may be implemented between a plurality of APs. For example, TXOP sharing between a plurality of APs may be implemented based on coordinated-AP time division multiple access (coordinated-AP time division multiple access, CAP TDMA).

FIG. 2 is an example diagram of sharing a TXOP between APs in a CAP TDMA process. Compared with enhanced distributed channel access (enhanced distributed channel access, EDCA), in a CAP TDMA process, an AP that gains medium access permission divides TXOP duration, and shares all frequency resources in a relatively small TXOP duration block with a neighboring AP. As shown in FIG. 2, in a case that an AP 1 obtains medium access permission, the AP 1 may share a frequency domain resource in a TXOP duration block with a neighboring AP (an AP 2, an AP 3, or an AP 4). In a case that an AP 2 obtains medium access permission, the AP 2 may share a frequency domain resource in a TXOP duration block with a neighboring AP (an AP 1, an AP 3, or an AP 4).

It should be noted that, when the CAP TDMA is used, the following conditions are required to be met: all APs participating in CAP transmission belong to a same extended service set (extended service set, ESS); an AP cannot manage an overlapping basic service set (overlapping basic service set, OBSS) STA; APs participating in CAP transmission are in coverage of each other and thus can communicate directly with each other; it is unnecessary to share a same primary 20 MHz channel among all APs participating in CAP transmission; there is no pre-allocated primary AP or no pre-allocated AP group; a holder of a TXOP coordinates time resources in the TXOP; air interfaces are used for coordination between APs.

As shown in FIG. 3, a process of CAP TDMA may include transmission indication and request (TX Ind & Req), scheduling allocation (schedule Alloc), and data transmission (data TX).

For example, an AP 1 that obtains a TXOP may transmit an indication to another AP to query whether the another AP is willing to participate in the CAP TDMA. If the another AP expects to participate in the CAP TDMA initiated by the AP 1, the another AP may respond to the indication of the AP 1. The AP 1 notifies the another AP of a start time and duration of the TXOP allocated to the another AP. In TXOP allocated time, the another AP to which the TXOP is allocated may perform data transmission with an associated non-AP STA.

An expected benefit of the CAP TDMA may include one or more of the following: reducing a delay in a worst-case scenario; or improving throughput fairness. A main advantage of the CAP TDMA is low delay, that is, the CAP TDMA may be used to improve a worst-case delay in a multi-BSS scenario. When the AP frequently shares the TXOP, the AP may help each node to access media more. For devices experiencing interference, the CAP TDMA may also help more transmission for these devices, providing more equitable throughput.

A maximum limitation of the CAP TDMA is that two APs that share a TXOP are required to be in coverage of each other. The reason why the two APs are required to be in coverage of each other is that this can make the two APs (such as an AP 1 and an AP 2) communicate directly through an air interface. In this case, low-latency data of all non-AP STAs associated with the AP 1 and all non-AP STAs associated with the AP 2 can be transmitted more quickly compared to a case that there is no CAP TDMA. The reason is that when there is no CAP TDMA, the non-AP STAs associated with the AP 1 can transmit data only by means of contending for an access channel or by scheduling by the AP 1. The AP 1 is located in coverage of the AP 2. If the AP 2 accesses a channel, in a time period in which the AP 2 acquires a TXOP, neither the AP 1 nor the non-AP STAs associated with the AP 1 can perform data transmission. Similarly to the AP 2, in a time period in which the AP 1 accesses a channel, neither the AP 2 nor the non-AP STAs associated with the AP 2 can perform data transmission. Therefore, if the AP or the non-AP STAs have low-latency data, the low-latency data cannot be transmitted immediately, that is, a delay is relatively long. The CAP TDMA helps to solve the problem. If the AP 1 accesses a channel, the AP 1 may share a part of its TXOP with the AP 2, to enable the AP 2 to complete data transmission with an associated non-AP STA. Similarly, if the AP 2 accesses a channel, the AP 2 may share a part of its TXOP with the AP 1, to enable the AP 1 to complete data transmission with an associated non-AP STA.

It may be learned from the foregoing content that, a related technology may be used to implement sharing of a TXOP between devices. For example, based on a TXOP sharing technology, an AP may share a TXOP with an associated non-AP STA. For another example, in a case that the two APs are in coverage of each other, the two APs may share, by using CAP TDMA, a TXOP acquired by one of the APs.

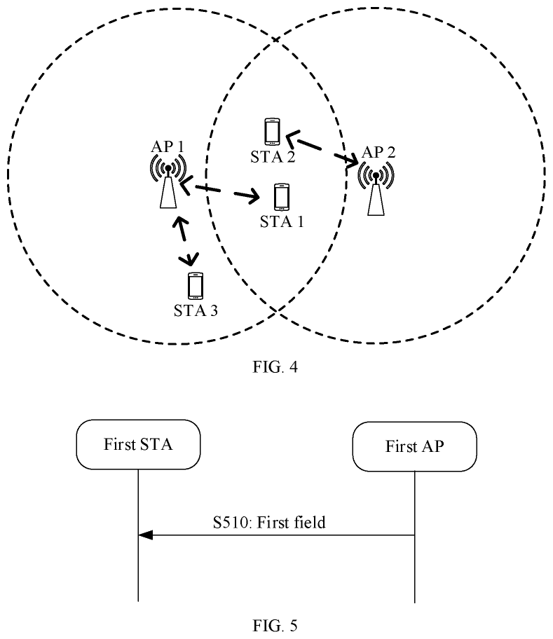

However, for a STA not associated with the AP, the AP cannot share a TXOP with the STA. As shown in the foregoing analysis, if the STA is in coverage of the AP, a problem of a relatively large transmission delay and relatively low throughput of the STA may be caused. The following analyzes with reference to FIG. 4.

As shown in FIG. 4, coverage of an AP 1 and coverage of an AP 2 are respectively shown in circular dashed frames. The AP 1 is associated with a STA 1 and a STA 3 (each represented by a dashed line of two arrows), and the AP 2 is associated with a STA 2. The STA 1 is in the coverage of the AP 2, and the STA 2 is in the coverage of the AP 2. Thus, compared to the STA 3, the STA 1 is affected by interference from a device in coverage of the AP 2. For example, whether the AP 2 or the STA 2 accesses a channel, a basic network allocation vector (network allocation vector, NAV) of the STA 1 is set, and thus the STA 1 cannot access the channel in this time period. In other words, in a TXOP acquired by the AP 2, the STA 1 cannot access the channel. In a case of failing to access the channel, if the STA 1 has to-be-transmitted data (for example, low-latency data (also referred to as delay-sensitive data)), the STA 1 cannot transmit the data in a timely manner, thus causing a relatively long delay. In addition, if the STA 1 and the STA 3 have a same data amount to wait for transmission, because the STA 1 receives more interference, a longer time period is required for the STA 1 to transmit the data amount. In this case, throughput of the STA 1 is less than throughput of the STA 3.

In view of the foregoing problem, this application provides the method illustrated in FIG. 5. FIG. 5 is a schematic flowchart of a wireless communication method according to an embodiment of this application. The method shown in FIG. 5 may be executed by a first STA and a first AP.

The first AP may be a device that acquires a TXOP. In other words, the first AP may be a TXOP holder.

The first STA may be associated with a second AP. For example, the first STA may be a non-AP STA associated with the second AP. The second AP may be an AP different from the first AP. In other words, the first STA is not associated with the first AP.

The first STA may be in coverage of the first AP for transmitting a signal. For example, the first STA may be in a basic service set (basic service set, BSS) (hereinafter referred to as a first BSS) corresponding to the first AP. As described above, the first STA may be associated with the second AP. Therefore, the first STA may be in a BSS (hereinafter referred to as a second BSS) corresponding to the second AP. In this case, the first STA is in both the first BSS and the second BSS. In other words, the first STA is in an OBSS. Therefore, the first STA may also be referred to as an OBSS non-AP STA.

A scenario shown in FIG. 4 is used as an example. The first AP may be the AP 2, the first STA may be the STA 1, and the second AP may be the AP 1. As shown in FIG. 4, the STA 1 is located in a BSS of the AP 2, but the STA 1 is associated with the AP 1. In other words, the STA 1 is in coverage of the AP 2 for transmitting a signal, but is not associated with the AP 2.

The method illustrated in FIG. 5 may include step S510.

Step S510: The first STA receives a first field transmitted by the first AP.

The first field may carry first information. The first information may be used to indicate that the first AP shares a part of a TXOP acquired by the first AP with the first STA.

In some embodiments, the first field may include a newly added field. A newly added field may occupy one or more bits in a reserved field in a related technology. In some other embodiments, the first field may include an existing field in the related technology. For example, when the existing field is a specific value, it may indicate that at least one of the existing field or a field related to the existing field carries the first information.

The first field may include one or more fields. In other words, the first information may be indicated by using one field, or may be indicated by using a plurality of fields.

In some embodiments, the first field may be carried in a first trigger frame. The first trigger frame may be, for example, an MU-RTS TXS trigger frame. For example, the first field may include a triggered TXOP sharing mode (Triggered TXOP Sharing Mode) subfield in the MU-RTS TXS trigger frame. For example, if the triggered TXOP sharing mode subfield is a first value, it may indicate that the MU-RTS TXS trigger frame is used to share a part of a TXOP with a non-associated STA. The first value may be greater than or equal to 3. For another example, the first field may include a newly added field in the MU-RTS TXS trigger frame. If the newly added field is a second value, it may indicate that the MU-RTS TXS trigger frame is used to share a part of a TXOP with a non-associated STA. The second value may be a number greater than or equal to 0.

The first information may be further used to indicate information about a TXOP shared by the first AP with the first STA. The information about the TXOP shared by the first AP with the first STA may include one or more of the following: a start time of the shared TXOP, an end time of the shared TXOP, or duration of the shared TXOP. The shared TXOP may also be referred to as an allocated TXOP.

Although the first STA is not associated with the first AP, the first AP may share, by using the first field, a part of the TXOP acquired by the first AP with the first STA. The first STA may transmit data in a TXOP shared by the first AP, so as to improve throughput of the first STA and reduce a transmission delay of the first STA.

For example, when the first AP acquires the TXOP, if there is remaining part of the TXOP or there is no low-latency data waiting for transmission by a device in the first BSS, and if there is low-latency data waiting for transmission by the first STA, the first AP may share the part of the TXOP with the first STA, thereby improving throughput of the first STA.

For another example, if the first AP releases the remaining TXOP, a device that accesses a channel may not be the first STA, that is, the first STA may not be able to immediately access the channel. However, by using step S510, the first AP may accurately share the TXOP with the first STA, thereby improving a chance of the first STA successfully contending for a channel, and achieving fairness in device access to the channel. In a case that the first STA successfully contends for the channel, throughput of the first STA may be improved.

In addition, it may be learned from the foregoing that, if multi-AP TXOP sharing is implemented by using the CAP TDMA, two APs need to be in coverage of each other. In other words, in a related technology, for the first STA, if the first AP and the second AP are not in coverage of each other, the first AP cannot share the TXOP with the second AP for communication with the first STA. However, this application is not limited thereto. The first STA in overlapping coverage of two APs may acquire a shared TXOP by using first information, so as to solve problems such as how to urgently transmit a low-latency service and how to ensure fairness of throughput.

It should be noted that the first STA and the first AP may have a same primary channel or different primary channels. The primary channel of the first AP needs to be in an operating channel range of the first STA. The primary channel of the first STA should be in an operating channel range of the first AP. If the first AP shares a TXOP with the first STA, a channel allocated by the first AP to the first STA should include the primary channel of the first STA, and the channel allocated by the first AP to the first STA should include the primary channel of the first AP.

The following describes in detail a method of transmitting the first field to the first STA by the first AP.

In some embodiments, the first AP and the second AP may belong to a same VBSS. VBSS may refer to an infrastructure BSS with a group of coordinated APs. The group of coordinated APs in the VBSS may be referred to as a coordinated AP group. The coordinated AP group may include a plurality of APs, and the plurality of APs may coordinate with each other. The coordinated AP group may include a multi-AP coordinator and at least one member AP. The multi-AP coordinator may be configured to control the member AP in the VBSS.

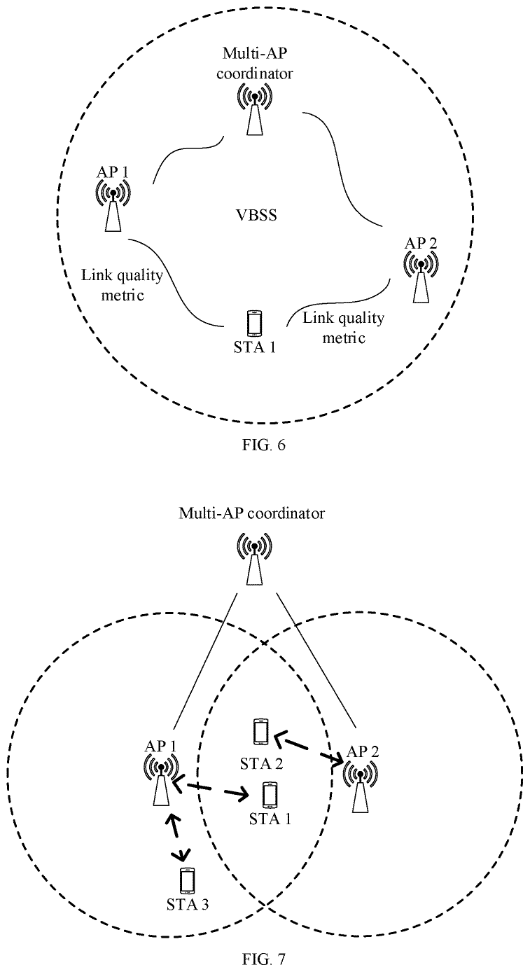

FIG. 6 is an example diagram of a VBSS. As shown in FIG. 6, the coordinated AP group in the VBSS includes a multi-AP coordinator, a member AP 1, and a member AP 2. Link quality metric may be performed between the AP 1 and a STA 1. For example, link quality metric may be implemented by means of a received signal strength indicator (receive signal strength indicator, RSSI). Similarly, link quality metric may be performed between the AP 2 and a STA 2. A plurality of APs may communicate with each other by using a backhaul link.

A non-AP STA may be served by one or more selected anchor APs. For a specific non-AP STA, some or all of the member APs in the VBSS may become anchor APs of the non-AP STA. For example, the anchor APs of the non-AP STA may be associated APs.

The VBSS may meet one or more of the following: all member APs may share a same service set ID (service set ID, SSID), that is, all member APs may belong to a same ESS; all member APs share association/authentication; when the non-AP STA roams in the VBSS, association/authentication is unnecessary to be performed again; the non-AP STA uses a same association identifier (association identifier, AID) in the VBSS, that is, the non-AP STA has a globally unique AID in the VBSS; the non-AP STA locally reserves capabilities information of the anchor AP and a neighboring AP; all member APs work on a same channel; or the non-AP STA can receive data from any member AP in the VBSS.

Based on the VBSS, multi-AP coordinated communication is implemented by using a related technology. Based on the VBSS, information exchange between the first STA and the first AP may be implemented in this application. Information exchange between the first STA and the first AP may be implemented based on one or more of the following features of the VBSS: based on the VBSS architecture, the AP may acquire information about all non-AP STAs in coverage of the AP, even if the AP is not associated with the non-AP STAs; based on the VBSS architecture, a non-AP STA may acquire information about all APs (including an anchor AP and a neighboring AP) in coverage of the non-AP STA; or the non-AP STA has a globally unique AID in the VBSS.

In an example in which the first AP transmits the first field to the first STA, the first AP may transmit the first field via the second AP associated with the first STA. The first AP and the second AP may communicate with each other by using a backhaul link. Alternatively, the first AP and the second AP may communicate with each other by using a backhaul link and via a multi-AP coordinator.

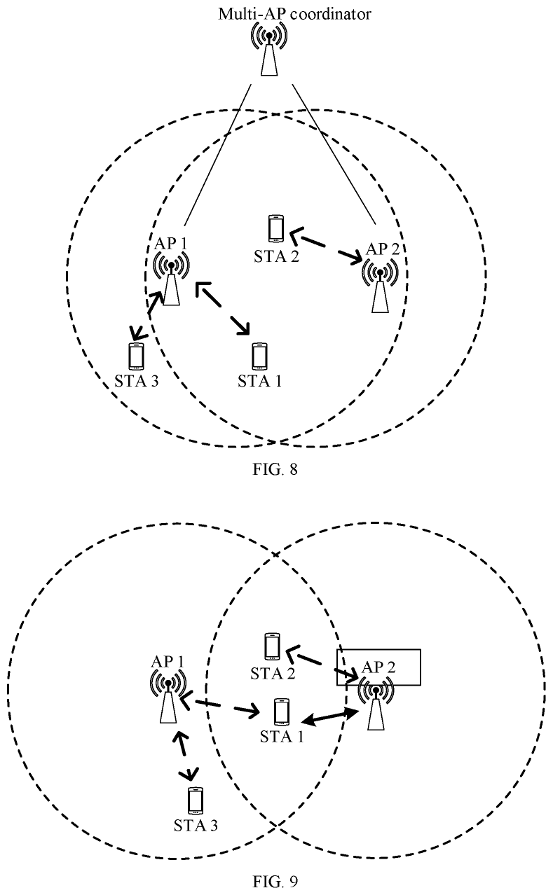

The following uses FIG. 7 and FIG. 8 as examples to describe a VBSS-based technical solution. The first AP may be an AP 2 shown in FIG. 7 or FIG. 8, the first STA may be a STA 1 shown in FIG. 7 or FIG. 8, and the second AP may be an AP 1 shown in FIG. 7 or FIG. 8. The AP 1, the AP 2, and a multi-AP coordinator may form a VBSS. The AP 1 and the AP 2 have a same SSID and belong to a same ESS. The AP 1 and the AP 2 may be controlled by the multi-AP coordinator, and both the AP 1 and the AP 2 establish a backhaul link (represented by black solid lines) with the multi-AP coordinator. An anchor AP of the STA 1 and a STA 3 may be the AP 1. An anchor AP of a STA 2 may be the AP 2. The STA 1, the STA 2 and the STA 3 each have a globally unique AID in the VBSS. The AP 2 may first transmit a first field to the multi-AP coordinator. The multi-AP coordinator then transmits the first field to the AP 1. The AP 1 transmits the received first field to the STA 1.

It should be noted that the first AP and the second AP in the VBSS may not be in coverage of each other. As shown in FIG. 7, the AP 1 and the AP 2 are not in coverage of each other. In this case, the first AP and the second AP cannot directly communicate with each other by using an air interface. Therefore, for the first AP and the second AP, a TXOP acquired by the first AP cannot be shared with the second AP by using a technical solution of CAP TDMA, to implement communication between the first STA and the second AP. Based on this application, even if the first AP and the second AP are not in coverage of each other, the first AP may share the TXOP acquired by the first AP with the first STA.

It should be noted that the first AP and the second AP in the VBSS may be in coverage of each other. As shown in FIG. 8, the AP 1 and the AP 2 are in coverage of each other. In this case, at any instant, only one AP of the first AP and the second AP can access a channel.

The foregoing describes the VBSS-based technical solution. The following describes a virtual association technical solution.

In some embodiments, the first STA may be in virtual association with the first AP. Control information and/or management information may be transmitted between virtual associated devices, but data cannot be transmitted therebetween. The first STA may be in virtual association with one or more APs. In other words, although the first STA can only establish an association with the second AP, the first STA may establish a virtual association with one or more APs.

It should be noted that, virtual associations may also be established between APs. For example, when the second AP is located in coverage of signal transmission of the first AP, and the first AP is located in coverage of signal transmission of the second AP (that is, the first AP and the second AP are located in coverage of each other), the second AP may be in virtual association with the first AP. In a case that the second AP may be in virtual association with the first AP, control information and/or management information may be transmitted between the first AP and the second AP, but data cannot be transmitted therebetween.

It should be noted that both an AP (namely, the first AP) that establishes a virtual association with the first STA and an AP (namely, the second AP) that establishes an association with the first STA belong to a same ESS. A plurality of virtual associated APs need to belong to a same ESS.

The first AP may allocate a unique AID to a device in virtual association with the first AP. Therefore, even if the first STA is not associated with the first AP, in a case that the first STA is in virtual association with the first AP, the first AP may allocate an AID to the first STA. Based on the AID allocated by the first AP to the first STA, the first AP may communicate with the first STA. For example, based on the AID allocated by the first AP to the first STA, the first AP may transmit the first field to the first STA.

It should be noted that the virtual association does not affect use of an original NAV. For example, the STA may consider an NAV set in a BSS in which a virtual associated AP is located as a basic NAV, and an NAV set in a BSS in which an associated AP is located as an intra NAV.

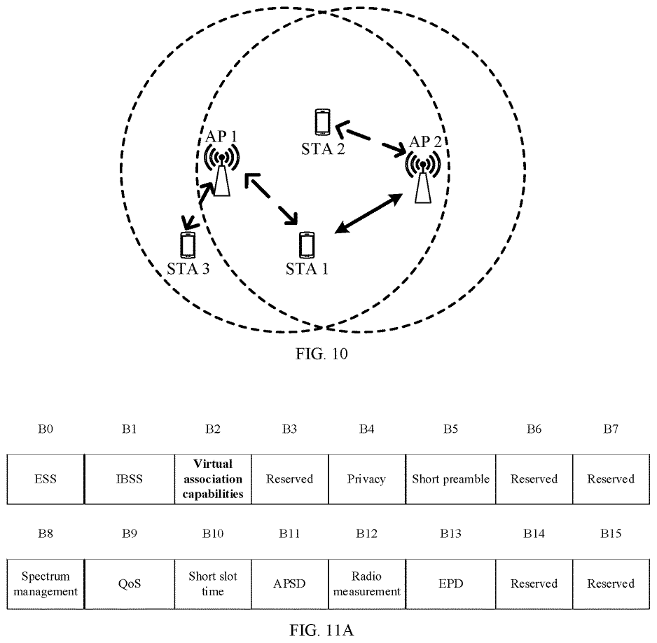

The following describes technical solutions of virtual association with reference to FIG. 9 and FIG. 10. The first AP may be an AP 2 shown in FIG. 9 or FIG. 10, the first STA may be a STA 1 shown in FIG. 9 or FIG. 10, and the second AP may be an AP 1 shown in FIG. 9 or FIG. 10. The AP 1 is associated with the STA 1 and a STA 3 (indicated by dashed lines of two arrows); and the AP 2 is associated with a STA 2. The AP 1 and the AP 2 have a same SSID and belong to a same ESS. The STA 1 may be in virtual association with the AP 2 (represented by a solid line of two arrows in the figures). After the virtual association is established between the STA 1 and the AP 2, control information and/or management information may be transmitted between the STA 1 and the AP 2.

It should be noted that the first AP and the second AP may not in coverage of each other. As shown in FIG. 9, the AP 1 and the AP 2 are not in coverage of each other. In this case, the first AP and the second AP cannot directly communicate with each other by using an air interface. Therefore, for the first AP and the second AP, a TXOP acquired by the first AP cannot be shared with the second AP by using multi-AP TXOP sharing, to implement communication between the first STA and the second AP. Based on this application, even if the first AP and the second AP are not in coverage of each other, the first AP may share the TXOP acquired by the first AP with the virtual associated first STA in virtual association with the first AP.

It should be noted that the first AP and the second AP may be in coverage of each other. As shown in FIG. 10, the AP 1 and the AP 2 are in coverage of each other. In this case, at any instant, only one AP of the first AP and the second AP can access a channel. In a case that the first AP accesses the channel, the first AP may share the TXOP acquired by the first AP with the first STA in virtual association with the first AP. Alternatively, the first AP may share the TXOP acquired by the first AP with the second AP in virtual association with the first AP.

It should be noted that a process of establishing a virtual association may be similar to a process of establishing an association between an AP and a non-AP STA in the related technology. Major differences lie in that: a device needs to indicate a status of supporting a virtual association; and the device needs to declare that the virtual association is to be established. Details are described as follows.

In some embodiments, the first AP may transmit virtual association capabilities information. The virtual association capabilities information may indicate whether the first AP supports another device to establish a virtual association with the first AP.

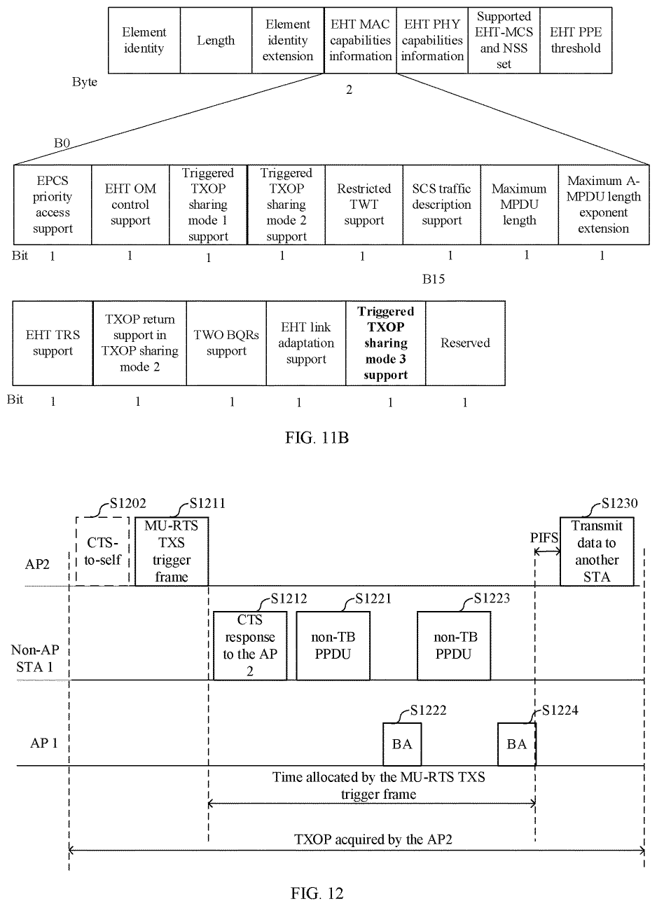

The virtual association capabilities information may be carried in a virtual association capabilities subfield in a capabilities information field. The capabilities information field may be carried in a beacon frame or a probe response frame. FIG. 11A is an example diagram of the capabilities information field. The capabilities information field may include one or more of the following fields: an ESS, an independent basic service set (independent BSS, IBSS), a reserved field, privacy (Privacy), a short preamble (Short Preamble), spectrum management (Spectrum Management), quality of service (quality of service, QoS), a short slot time (Short Slot Time), automatic power save delivery (automatic power save delivery, APSD), radio measurement (Radio Measurement), or end process delay (end process delay, EPD).

For example, the virtual association capabilities information being 0 may indicate that the first AP does not support establishing a virtual association between a communications device and the first AP; the virtual association capabilities information being 1 may indicate that the first AP supports establishing a virtual association between a communications device and the first AP. Alternatively, the virtual association capabilities information being 1 may indicate that the first AP does not support establishing a virtual association between a communications device and the first AP; the virtual association capabilities information being 0 may indicate that the first AP supports establishing a virtual association between a communications device and the first AP.

The first STA or the second AP may transmit virtual association request information. The virtual association request information may be used to indicate that the first STA or the second AP requests to establish a virtual association.

The virtual association request information may be carried in a virtual association capabilities subfield in a capabilities information field. The capabilities information field may be carried in an association requestframe. FIG. 11A is an example diagram of the capabilities information field.

For example, the virtual association request information being 0 may indicate that a virtual association is requested to be established by the first STA or the second AP; the virtual association request information being 1 may indicate that a non-virtual association is requested to be established by the first STA or the second AP. Alternatively, the virtual association request information being 1 may indicate that a virtual association is requested to be established by the first STA or the second AP; the virtual association request information being 0 may indicate that a non-virtual association is requested to be established by the first STA or the second AP.

The first AP may transmit virtual association response information. The virtual association response information may be used to indicate that a virtual association is to be established by the first AP.

The virtual association response information may be carried in the virtual association capabilities subfield in the capabilities information field. The capabilities information field may be carried in an association response frame. FIG. 11A is an example diagram of the capabilities information field.

For example, the virtual association response information being 0 may indicate that a virtual association is to be established by the first AP; the virtual association response information being 1 may indicate that a non-virtual association is to be established by the first AP. Alternatively, the virtual association response information being 1 may indicate that a virtual association is to be established by the first AP; the virtual association response information being 0 may indicate that a non-virtual association is to be established by the first AP.

As mentioned above, a virtual association may also be established between two APs. One of the two APs may be a primary AP, and the other may be a secondary AP. For example, an AP that transmits the association virtual association request information may be the secondary AP, and an AP that transmits the virtual association response information may be the primary AP.

Based on the VBSS solution and/or the virtual association solution described above, a TXOP sharing solution for an AP and a non-associated STA may be implemented. The TXOP sharing solution may include one or more of the following: a capability indication, a buffer status report, scheduling allocation, or data transmission, which are described below.

### Capability Indication

In some embodiments, the first AP or the first STA may declare whether to support OBSS TXOP sharing. For the first AP, the OBSS TXOP sharing may include that the first AP can share a TXOP with the first STA. Alternatively, the OBSS TXOP sharing may include that the first AP supports sharing of a TXOP with a device in the OBSS. For the first STA or the second AP, the OBSS TXOP sharing may include that the first STA or the second AP can use the TXOP shared by the first AP. Alternatively, the OBSS TXOP sharing may include that the first STA or the second AP supports using a TXOP shared by a non-associated AP in the OBSS. Alternatively, the OBSS TXOP sharing may include that the first STA or the second AP is willing to participate in a TXOP shared by a non-associated AP in the OBSS.

The OBBS TXOP sharing may be represented by a new TXOP sharing mode. For example, an OBBS TXOP sharing capability may be represented by a TXOP sharing mode 3 (TXOP Sharing Mode 3).

It should be noted that there may be two modes for TXOP sharing in a related technology. The two modes may be a TXOP sharing mode 1 (TXOP Sharing Mode 1) and a TXOP sharing mode 2 (TXOP Sharing Mode 2). For example, a triggered TXOP sharing mode 1 support (Triggered TXOP Sharing Mode 1 Support) subfield and a triggered TXOP sharing mode 2 support (Triggered TXOP Sharing Mode 2 Support) subfield in an EHT MAC capabilities information field in an EHT capabilities element indicate whether a current STA supports the TXOP sharing mode 1 and the TXOP sharing mode 2, respectively. The OBBS TXOP sharing capability described above may be represented by using a TXOP sharing mode 3, so as to be distinguished from a TXOP sharing mode in a related technology. Therefore, the OBBS TXOP sharing capability may alternatively be represented by using a TXOP sharing mode of another sequence number, provided that the sequence number is different from the TXOP mode in the related technology.

In some embodiments, the first AP may transmit first capabilities information. The first capabilities information may be used to indicate whether the first AP supports OBSS TXOP sharing.

In some embodiments, the first STA may transmit second capabilities information, and the second capabilities information may be used to indicate whether the first STA supports OBSS TXOP sharing.

The first capabilities information or the second capabilities information may be carried in a field in a capabilities element. In other words, whether a device supports OBSS TXOP sharing may be indicated by using the field in the capabilities element. For example, the first capabilities information and the second capabilities information may be carried in a same field in the capabilities element. When the first AP transmits the field, the field may indicate the first capabilities information. When the first STA transmits the field, the field may indicate the second capabilities information.

The capabilities element may include, for example, the EHT capabilities element. For example, the information about whether the device supports OBSS TXOP sharing may be carried in, for example, a subfield in the EHT MAC capabilities information field in the EHT capabilities element. The subfield may be a newly-added “triggered TXOP sharing mode 3 support” (Triggered TXOP Sharing Mode 3 Support) subfield.

For example, for an AP, if the “triggered TXOP sharing mode 3 support” subfield is set to N, it indicates that the AP can transmit an MU-RTS TXS trigger frame, and allocate a segment of a TXOP to the first STA or a secondary AP. Alternatively, for an AP, if the “triggered TXOP sharing mode 3 support” subfield is set to N, it indicates that the AP can respond to an MU-RTS TXS trigger frame as a secondary AP, and transmit information to an associated device or a virtual associated device by using a TXOP shared by another AP. If the “triggered TXOP sharing mode 3 support” subfield is set to M, it indicates that the AP cannot transmit the MU-RTS TXS trigger frame, or cannot allocate a segment of a TXOP to the first STA or a secondary AP. Alternatively, if the “triggered TXOP sharing mode 3 support” subfield is set to M, it indicates that the AP cannot respond to the MU-RTS TXS trigger frame as a secondary AP, or the AP cannot transmit, as a secondary AP, information to an associated device or a virtual associated device by using a TXOP shared by another AP. Herein N may be 1, and M may be 0. Alternatively, N may be 0, and M may be 1.

For another example, for the first STA, if the “triggered TXOP sharing mode 3 support” subfield is set to N, it indicates that the first STA may respond to an MU-RTS TXS trigger frame, and the MU-RTS TXS trigger frame is used to allocate a TXOP to the first STA or a secondary AP. If the “triggered TXOP sharing mode 3 support” subfield is set to M, it indicates that the first STA cannot respond to an MU-RTS TXS trigger frame, and the MU-RTS TXS trigger frame cannot be used to allocate a TXOP to the first STA. Herein N may be 1, and M may be 0. Alternatively, N may be 0, and M may be 1.

In some implementations, the “triggered TXOP sharing mode 3 support” (Triggered TXOP Sharing Mode3 Support) subfield may be a subfield added to BIT14 in the EHT MAC capabilities information field of the EHT capabilities element. FIG. 11B is an example diagram of a format of an EHT MAC capabilities information field. As shown in FIG. 11B, the EHT capabilities element may include the following fields: an element identity (Element ID), a length (Length), element identity extension (Element ID Extension), EHT MAC capabilities information, EHT PHY capabilities information (EHT PHY Capabilities Information), a supported EHT-MCS and NSS set (Supported EHT-MCS And NSS Set), and an EHT PPE threshold (optional) (EHT PPE Thresholds (Optional)). The EHT MAC capabilities information field includes a triggered TXOP sharing mode 3 support subfield (represented by a gray background box). The EHT MAC capabilities information field may further include the following subfields: EPCS priority access support (EPCS Priority Access Support), EHT OM control support (EHT OM Control Support), triggered TXOP sharing mode 1 support (Triggered TXOP Sharing Mode1 Support), triggered TXOP sharing mode 2 support (Triggered TXOP Sharing Mode2 Support), restricted TWT support (Restricted TWT Support), SCS traffic description support (SCS Traffic Description Support), maximum MPDU length (Maximum MPDU Length), maximum A-MPDU length exponent extension (Maximum A-MPDU Length Exponent Extension), EHT TRS support (EHT TRS Support), TXOP return support in TXOP sharing mode 2 (TXOP Return Support In TXOP Sharing Mode2), TWO BQRs support (TWO BQRs Support), EHT link adaptation support (EHT Link Adaptation Support), and reserved field.

### Buffer Status Report

In some embodiments, the first STA may transmit second information to the first AP. The second information may be used to indicate buffer information of the first STA. The buffer information may include, for example, a buffer status. The buffer status may include, for example, one or more of the following information: to-be-transmitted data amount, whether there is to-be-transmitted delay-sensitive data amount, to-be-transmitted delay-sensitive data amount, or the like.

Based on the second information, the first AP may acquire a buffer status of the first STA, so as to allocate a resource to the first STA. For example, the first AP may allocate a TXOP to the first STA based on the second information, so that the first STA completes transmission of to-be-transmitted data and/or to-be-transmitted delay-sensitive data.

As described above, interaction between the first STA and the first AP may be implemented based on a VBSS and/or virtual association, which are described below.

For example, the first AP and the second AP may belong to a same VBSS. Optionally, the first STA may transmit the second information to the first AP via the second AP. For example, the first STA may transmit the second information to the second AP, and the second AP may indirectly transmit the second information to a neighboring AP (for example, the first AP) of the first STA via a multi-AP coordinator.

For another example, the first STA may be in virtual association with the first AP. Based on the virtual association between the first STA and the first AP, the first STA may transmit the second information to the first AP. Alternatively, the second AP may be in virtual association with the first AP. Based on the virtual association between the second AP and the first AP, the first STA may transmit the second information to the first AP via the second AP. It may be learned from the foregoing that, after the virtual association is established, the first AP may learn information about all non-AP STAs/APs that establish a virtual association in coverage of the first AP. Both an associated non-AP STA and a virtual associated non-AP STA/AP have a unique AID. Similarly, the non-AP STA/AP may learn information about an AP with which a virtual association is established. Therefore, based on the virtual association between the first STA/second AP and the first AP, the first STA may transmit the second information to the first AP.

Similarly, in a case that the first AP is in virtual association with the second AP, the second AP may transmit buffer information of the second AP, so that the first AP allocates a shared TXOP to the second AP. For example, for the scenario illustrated in FIG. 10, the first AP is an AP 2, and the second AP is an AP 1. The AP 2 is a primary AP, and the AP 1 is a secondary AP. To allocate a TXOP to the AP 1, the AP 2 needs to learn buffer information of the AP 1. The AP 1 needs to report a buffer status by using the second information, to make the AP 2 learn the buffer status of the AP 1, and help allocate resources.

In some embodiments, in response to the first STA receiving first trigger information transmitted by the first AP, the first STA transmits the second information to the first AP. In other words, only when the first AP transmits the first trigger information or the first STA receives the first trigger information, the first STA transmits the second information to the first AP. In other words, the first trigger information may be used to request acquiring the buffer information of the first STA.

Optionally, the first AP may directly transmit the first trigger information to the first STA. Alternatively, the first AP may transmit the first trigger information to the first STA via the second AP. In other words, the first AP may trigger the second AP associated with the first STA, and may acquire the buffer information of the first STA via the second AP.

The first trigger information may be carried in a first trigger frame, and the second information may be carried in a response frame corresponding to the first trigger frame.

In some implementations, the first trigger frame may be a buffer status report poll (buffer status report poll, BSRP) frame. In other words, by multiplexing the BSRP frame, the first AP may initiate an explicit buffer status report request for the first STA. The first STA may respond to the buffer information of the first STA to the first AP.

In some implementations, the first trigger frame may be a trigger frame of a new type. The new type may be a first type. The first type may be referred to as, for example, an OBSS BSRP. Correspondingly, the first type of a trigger frame may be referred to as an OBSS BSRP frame.

For the first type of the trigger frame, one user information (User Info) field may include AID information of the first STA. An RA field of the first type of the trigger frame may point to the first STA.

A manner of adding the first type of the trigger frame may be as follows: adding the first type to a trigger type (Trigger Type) subfield of a common information (Common Info) field of the trigger frame. For example, a trigger type subfield encoding (Trigger Type subfield value) corresponding to the first type may be a value greater than 7 and less than 16.

Table 1 is an example diagram of trigger type subfield encoding. As shown in Table 1, the first type is OBSS BSRP, and a value of a trigger type subfield corresponding to the first type is 8.

TABLE 1

| Trigger type | Trigger frame variant |
|---|---|
| subfield encoding | (trigger frame variant) |
| 0 | Basic (BASIC) |
| 1 | Beamforming report poll (beamforming report |
| | poll, BFRP) |
| 2 | Multi-user BAR (MU-BAR) |
| 3 | Multi-user request to send (multi-user |
| | request to send, MU-RTS) |
| 4 | BSRP |
| 5 | Groupcast with retries multi-user BAR |
| | (GCR MU-BAR) |
| 6 | Bandwidth query report poll (bandwidth |
| | query report poll, BQRP) |
| 7 | NDP Feedback Report Poll (NDP feedback |
| | report poll, NFRP) |
| 8 | OBSS BSRP |
| 9-15 | Reserved (reserved) |

In some embodiments, in a case that a first condition is met, the first STA transmits the second information to the first AP. For the first trigger information, the first condition may be a response condition of the first trigger information. In other words, only when the first condition is met, the first STA may respond to the first trigger information and transmit the second information.

In some embodiments, in a case that the first condition is met, the second AP that is in virtual association with the first AP may transmit the second information to the first AP.

Optionally, the first condition may include that: a value of an internal NAV of the first STA is 0, and basic network allocation vectors of the first STA that are set by all other device than the first AP are 0. It may be understood that the first condition ignores a basic NAV of the first STA set by the first AP. If the internal NAV of the first STA is not 0, a device in a BSS in which the second AP associated with the first STA is located occupies a channel. Thus, the first STA cannot transmit the second information to the first AP. The basic NAV of the first STA may be set by a device that is not associated with the first STA. If the basic NAV set by the device different from the first AP is not 0, another device other than the first AP and the second AP occupies the channel. Thus, the first STA cannot transmit the second information to the first AP.

Optionally, the first condition may include that a channel is not detected as busy by physical carrier sensing of the first STA. When it is detected based on the physical carrier sense of the first STA that the channel is busy, the first STA cannot transmit the second information on the busy channel.

### Scheduling Allocation

In some embodiments, the first STA receives third information transmitted by the first AP. The third information may be used to indicate that the first AP initiates a TXOP sharing procedure for the first STA. Alternatively, the third information may be used to indicate information about a TXOP allocated by the first AP to the first STA.

It may be understood that, based on the third information, the foregoing OBSS TXOP sharing capability may be implemented.

The third information may be carried in a second field. The second field may be, for example, a triggered TXOP sharing mode (Triggered TXOP Sharing Mode) subfield in an MU-RTS TXS trigger frame.

The second field being a first value may indicate that the first AP initiates the TXOP sharing procedure for the first STA. Table 2 is described by using an example in which the second field is a triggered TXOP sharing mode subfield and the first value is 3.

| Value of the | |
|---|---|
| triggered TXOP | |
| sharing mode | |
| subfield | Description |
| 0 | Common MU-RTS frame |
| 1 | MU-RTS frame that initiates MU-RTS TXOP sharing procedure, where |
| | a scheduled STA can only transmit data to its associated AP |
| 2 | MU-RTS frame that initiates MU-RTS TXOP sharing procedure, where |
| | a scheduled STA can transmit data to its associated AP or another STA |
| 3 | MU-RTS frame that initiates MU-RTS TXOP sharing procedure, where |
| | a scheduled OBSS non-AP STA can only transmit data to its associated |
| | AP or another non-AP STA, or a scheduled OBSS AP can only transmit |
| | a frame to its associated non-AP STA or a virtual associated non-AP |
| | STA/AP |

It may be learned from Table 3 that if the first AP supports OBSS TXOP sharing, it indicates that the TXOP sharing mode 3 newly added in this application is supported. A behavior of the first AP may include that: a transmitted MU-RTS TXS frame includes only one user information (User Info) field, and an AID subfield in the user information field is an AID of an unassociated STA that supports OBSS TXOP sharing and that is in coverage of an AP.

With reference to the OBSS TXOP sharing capability described, if a capability of a device supports OBSS TXOP sharing, it may indicate that a corresponding device supports transmission or responds to an MU-RTS TXS trigger frame, and a triggered TXOP sharing mode field is equal to 3.

It should be noted that the second field and a first field may include a same field. For example, the second field may be the same as the first field. In other words, an identical field may be used to carry either first information or third information. For example, both the first field and the second field may include a triggered TXOP sharing mode subfield in the MU-RTS TXS trigger frame. In a case that the triggered TXOP sharing mode subfield is a first value, the triggered TXOP sharing mode subfield may be used to indicate that the first AP initiates a TXOP sharing procedure for the first STA, and may be further used to indicate that the MU-RTS TXS trigger frame is used by the first AP to share a part of a TXOP acquired by the first AP with the first STA.

In some embodiments, in a case that a second condition is met, the first STA may transmit to the first AP response information to the third information. Alternatively, in a case that the second condition is met, the first STA may transmit response information to the first AP. For example, if the first AP receives the response information from the first STA, it may indicate that TXOP allocation succeeds; if no response information is received by the first AP from the first STA, it indicates that the TXOP allocation fails.

In a case that the third information is carried in a trigger frame, the response information may be carried in a clear to send (clear to send, CTS) frame. If the first AP receives the CTS frame from the first STA, it may indicate that TXOP allocation succeeds; if no CTS frame is received by the first AP from the first STA, it indicates that the TXOP allocation fails.

Optionally, the second condition may include that: a value of an internal NAV of the first STA is 0, and basic network allocation vectors of the first STA that are set by all other device than the first AP are 0. It may be understood that the second condition ignores a basic NAV of the first STA set by the first AP. If the internal NAV of the first STA is not 0, a device in a BSS in which the second AP associated with the first STA is located occupies a channel. Thus, the first STA cannot transmit the response information to the first AP. The basic NAV of the first STA may be set by a device that is not associated with the first STA. If the basic NAV set by the device different from the first AP is not 0, another device other than the first AP and the second AP occupies the channel. Thus, the first STA cannot transmit the response information to the first AP.

Optionally, the second condition may include that a channel is not detected as busy by physical carrier sensing of the first STA. When it is detected based on the physical carrier sense of the first STA that the channel is busy, the first STA cannot transmit the response information on the busy channel.

The following describes Case 1 and Case 2 by using a scenario illustrated in FIG. 7 as an example.

Case 1: A STA 1 and a STA 3 are not in coverage of each other.

As shown in FIG. 7, the STA 1 and the STA 3 are associated with an AP 1, and a STA 2 is associated with an AP 2. The STA 1 and the STA 3 are not in coverage of each other and cannot communicate directly through an air interface. It is assumed that the AP 2 expects to share its TXOP with the STA 1 and share the TXOP by using an MU-RTS TXS trigger frame. If the STA 1 can use the TXOP, the STA 1 may transmit a CTS frame to the AP 2; otherwise, the STA 1 may not transmit the CTS frame. Possible cases may include Case 1.1 and Case 1.2.

Case 1.1: The STA 3 is performing uplink transmission. The STA 1 may normally receive an MU-RTS TXS frame from the AP 2, and an internal NAV of the STA 1 may not be 0 (for example, may be set according to an RTS or CTS frame transmitted by the AP 1), or may be 0 (for example, the STA 1 is located in an OBSS area, and a conflict may occur when an RTS or CTS frame transmitted by the AP 1 is received on a STA 1 side, causing the internal NAV to be incorrectly set to 0). If the internal NAV of the STA 1 is not 0, the STA 1 will not return the CTS frame to the AP 2, and thus TXOP sharing of the AP 2 fails. If the internal NAV of the STA 1 is 0, all basic NAVs except for a basic NAV set by the AP 2 are 0, and it is detected based on physical carrier sense that the channel is idle, then the STA 1 may transmit the CTS frame to the AP 2.

Case 1.2: The STA 3 does not perform data transmission. The STA 1 normally receives an MU-RTS TXS frame from the AP 2. An internal NAV on the STA 1 side is 0. If all basic NAVs except for a basic NAV set by the AP 2 are 0, and it is detected based on physical carrier sense that the channel is idle, then a non-AP STA 1 may transmit the CTS frame to the AP 2.

Case 2: The STA 1 and the STA 3 are in coverage of each other.

As shown in FIG. 8, the STA 1 and the STA 3 are associated with an AP 1, and a STA 2 is associated with an AP 2. The STA 1 and the STA 3 are in coverage of each other and can communicate directly through an air interface. It is assumed that the AP 2 expects to share its TXOP with the STA 1 and a used frame is an MU-RTS TXS trigger frame. If the STA 1 can use the TXOP, the STA 1 may transmit a CTS frame to the AP 1. If the STA 1 cannot use the TXOP, the STA 1 will not transmit the CTS frame. Possible cases may include Case 2.1 and Case 2.2.

Case 2.1: The STA 3 is performing uplink transmission. To avoid conflicts with the uplink transmission of the STA 3, the STA 1 cannot normally receive an MU-RTS TXS frame from the AP 2. Alternatively, the STA 1 can successfully receive an MU-RTS TXS frame from the AP 2, but it is detected based on physical carrier sense that the channel is busy. In this case, the STA 1 will not transmit a CTS frame to the AP 2, and TXOP sharing initiated by the AP 2 fails.

Case 2.2: The STA 3 does not perform transmission. The STA 1 receives an MU-RTS TXS frame from the AP 2. If an internal NAV on the STA 1 side is 0, all basic NAVs except for a basic NAV set by the AP 2 are 0, and it is detected based on physical carrier sense that the channel is idle, then the STA 1 may transmit the CTS frame to the AP 2.

As described above, in a case that the second condition is not met, the first AP may fail to share a TXOP with the first STA. To improve a success rate of TXOP sharing, the following technical solutions are provided in this application.

In some embodiments, the first AP may receive TXOP information of the second AP transmitted by the second AP. The TXOP information may include, for example, one or more of the following information: a channel access status of the second AP, an end time of a TXOP acquired by the second AP, duration of a TXOP acquired by the second AP, or the like. Based on the TXOP information of the second AP, the first AP may acquire a channel occupation status in a BSS in which the first STA is located, so as to share the TXOP of the first AP with the first STA at a proper time.

For example, because the second AP is associated with the first STA, in the duration of the TXOP of the second AP, an internal NAV of the first STA is not 0. Based on this, in the duration of the TXOP of the second AP, the first AP may not share the TXOP with the first STA. In other words, a part of the TXOP shared by the first AP with the first STA is outside the duration of the TXOP of the second AP. Based on this implementation, a TXOP sharing failure caused when an internal NAV of the first STA is not 0 may be avoided.

Optionally, based on the VBSS and/or virtual association method described above, the second AP may transmit TXOP information of the second AP to the first AP.

For example, if an AP in the VBSS (for example, the second AP) acquires a channel access opportunity, the AP may transmit its channel access status and an end time of a TXOP to a multi-AP coordinator, and then the multi-AP coordinator shares the information with another AP (for example, the first AP). A scenario shown in FIG. 7 is used as an example. If the AP 2 learns, by using the multi-AP coordinator, an end time of a TXOP of the AP 1, then the AP 2 may not consider sharing a TXOP acquired by the AP 2 with the STA 1 associated with the AP 1 in the end time of the TXOP of the AP 1.

### Data Transmission

After the first AP successfully shares a TXOP with the first STA, the first STA may perform data transmission in the TXOP shared by the first AP. For example, the first STA may transmit data to the second AP and/or another STA. Alternatively, after the first AP successfully shares the TXOP with the second AP, the second AP may transmit a signal to an associated STA and/or a virtual associated STA in the TXOP shared by the first AP.

It should be noted that the first STA or the second AP can perform data transmission only in a time corresponding to a part of the TXOP shared by the first AP. The first STA or the second AP can complete data transmission only on a channel and bandwidth specified by the first AP.

The following describes a data transmission process in detail by using three embodiments with reference to FIG. 12 to FIG. 14.

### Embodiment 1

FIG. 12 is a schematic diagram of a method according to Embodiment 1. The method shown in FIG. 12 may be executed by an AP 1, an AP 2, and a STA 1. The AP 1, the AP 2, and the STA 1 may be corresponding communications devices in the scenario illustrated in any one of FIG. 7 to FIG. 10. The first AP is the AP 2, the second AP is the AP 1, and the first STA is the STA 1.

The method shown in Embodiment 1 may include steps S1211 to S1230.

Step S1211: The AP 2 transmits an MU-RTS TXS trigger frame to the STA 1. A value of a triggered TXOP sharing mode subfield in the MU-RTS TXS trigger frame is equal to 3.

The MU-RTS TXS trigger frame may be used to allocate a time to the STA 1. The time allocated by the MU-RTS TXS trigger frame is a part of a TXOP shared by the AP 2 with the STA 1.

Step S1212: The STA 1 transmits a CTS response to the AP 2.

In the time allocated by the MU-RTS TXS trigger frame, the STA 1 and the AP 1 may perform steps S1221 to S1224.

Step S1221: The STA 1 transmits an uplink non trigger based (non trigger based, non-TB) PPDU to the AP 1 associated with the STA 1.

Step S1222: For step S1221, the AP 1 transmits a block acknowledgement (block acknowledgement, BA) frame to the STA 1.

Step S1223: The STA 1 transmits an uplink non-TB PPDU to the AP 1.

Step S1224: For step S1222, the AP 1 transmits a BA frame to the STA 1.

Step S1230: After PIFS, the AP 2 may transmit data to another STA in a TXOP acquired by the AP 2.

Optionally, the step S1202 may be further performed before the step S1211.

Step S1202: The AP 2 performs CTS-to-self transmission.

### Embodiment 2

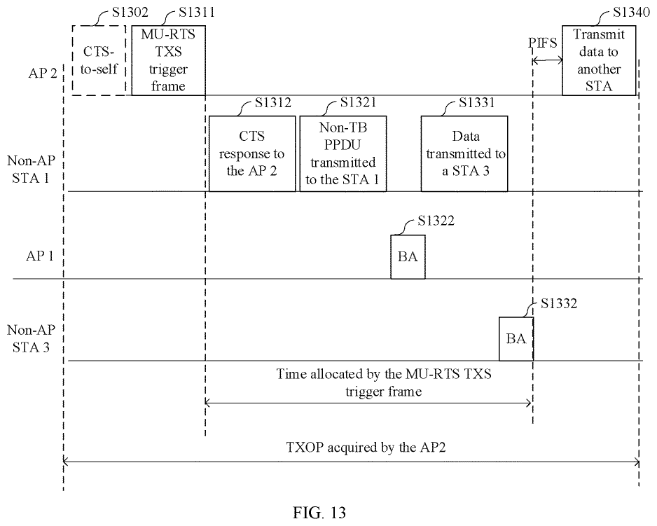

FIG. 13 is a schematic diagram of a method according to Embodiment 2. Embodiment 2 may be executed by an AP 1, an AP 2, a STA 1, and a STA 3. The AP 1, the AP 2, the STA 1, and the STA 3 may be corresponding communications devices in the scenario illustrated in any one of FIG. 7 to FIG. 10. The first AP is the AP 2, the second AP is the AP 1, and the first STA is the STA 1.

The method shown in Embodiment 2 may include steps S1311 to S1340.

Step S1311: The AP 2 transmits an MU-RTS TXS trigger frame to the STA 1. A value of a triggered TXOP sharing mode subfield in the MU-RTS TXS trigger frame is equal to 3.

The MU-RTS TXS trigger frame may be used to allocate a time to the STA 1. The time allocated by the MU-RTS TXS trigger frame is a part of a TXOP shared by the AP 2 with the STA 1.

Step S1312: The STA 1 transmits a CTS response to the AP 2.

In the time allocated by the MU-RTS TXS trigger frame, the STA 1 and the AP 1 may perform steps S1321 and S1332.

Step S1321: The STA 1 transmits a UL non-TB PPDU to the AP 1 associated with the STA 1.

Step S1322: For step S1321, the AP 1 transmits a BA frame to the STA 1.

Step S1331: The STA 1 transmits data to the STA 3.

Step S1332: For step S1331, the STA 3 transmits a BA frame to the STA 1.

Step S1340: After PIFS, the AP 2 may transmit data to another STA in a TXOP acquired by the AP 2.

Optionally, the step S1302 may be further performed before the step S1311.

Step S1302: The AP 2 performs CTS-to-self transmission.

### Embodiment 3

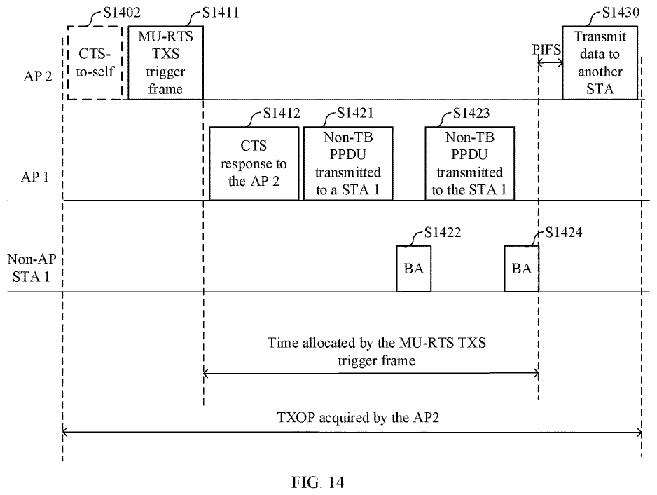

FIG. 14 is a schematic diagram of a method according to Embodiment 3. Embodiment 3 may be executed by an AP 1, an AP 2, and a STA 1. The AP 1, the AP 2, and the STA 1 may be corresponding communications devices in the scenario illustrated in FIG. 8 or FIG. 10. The first AP is the AP 2, the second AP is the AP 1, and the first STA is the STA 1.

The method shown in Embodiment 3 may include steps S1411 to S1430.

Step S1411: The AP 2 transmits an MU-RTS TXS trigger frame to the AP 1. A value of a triggered TXOP sharing mode subfield in the MU-RTS TXS trigger frame is equal to 3.

The MU-RTS TXS trigger frame may be used to allocate a time to the AP 1. The time allocated by the MU-RTS TXS trigger frame is a part of a TXOP shared by the AP 2 with the AP 1.

Step S1412: The AP 1 transmits a CTS response to the AP 2.

In the time allocated by the MU-RTS TXS trigger frame, the STA 1 and the AP 1 may perform steps S1421 and S1432.

Step S1421: The AP 1 transmits a downlink (downlink, DL) non-TB PPDU to the STA 1 associated with the AP 1.

Step S1422: For step S1421, the STA 1 transmits a BA frame to the AP 1.

Step S1423: The AP 1 transmits a non-TB PPDU to the STA 1.

Step S1424: For step S1424, the STA 1 transmits a BA frame to the AP 1.

Step S1430: After PIFS, the AP 2 may transmit data to another STA in a TXOP acquired by the AP 2.

Optionally, the step S1402 may be further performed before the step S1411.

Step S1402: The AP 2 performs CTS-to-self transmission.

It should be noted that in this application, the first AP and the second AP may belong to a same ESS. The first AP and the second AP may have a same SSID.

It should be noted that most of the foregoing embodiments are described by using an example in which the first AP shares a TXOP with the first STA. It may be understood that these embodiments may alternatively be applied to a case in which the first AP shares a TXOP with the second AP.

The foregoing describes the method embodiments of this application in detail. The following describes apparatus embodiments of this application in detail. It should be understood that the descriptions of the method embodiments correspond to descriptions of the apparatus embodiments, and therefore, for parts that are not described in detail, reference may be made to the foregoing method embodiments.

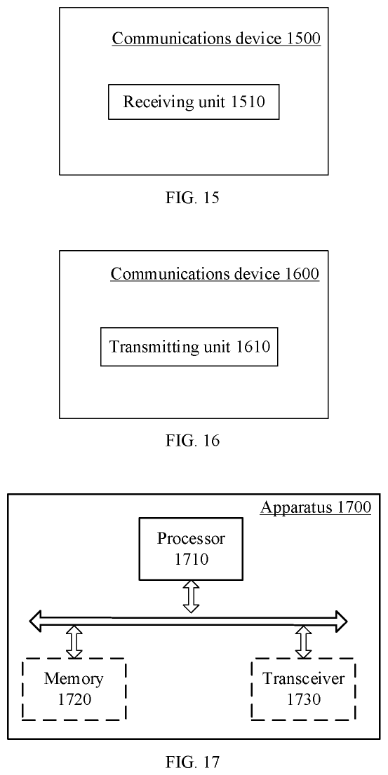

FIG. 15 is a schematic diagram of a structure of a communications device 1500 according to an embodiment of this application. The communications device 1500 may be a first STA. The communications device 1500 may include a receiving unit 1510.

The receiving unit 1510 is configured to receive a first field transmitted by a first AP. The first field is used to carry first information, and the first information is used to indicate that the first AP shares a part of a TXOP acquired by the first AP with the first STA. The first STA is associated with a second AP, and the first STA is in coverage of signal transmission of the first AP.

In some embodiments, the first AP and the second AP belong to a same VBSS.

In some embodiments, the receiving unit 1510 is specifically configured to receive, via the second AP, the first field transmitted by the first AP.

In some embodiments, the first STA is in virtual association with the first AP. In a case that the first STA is in virtual association with the first AP, control information and/or management information can be transmitted between the first AP and the first STA, and data cannot be transmitted between the first AP and the first STA.

In some embodiments, the receiving unit is specifically configured to receive, by using an AID allocated by the first AP to the first STA, the first field transmitted by the first AP.

In some embodiments, in a case that the second AP is in coverage of signal transmission of the first AP and the first AP is in coverage of signal transmission of the second AP, the second AP is in virtual association with the first AP; and in a case that the second AP is in virtual association with the first AP, the second AP and the first AP are allowed to transmit control information and/or management information to each other but are not allowed to transmit data to each other.

In some embodiments, the communications device 1500 is further configured to receive first capabilities information transmitted by the first AP. The first capabilities information is used to indicate whether the first AP can share a TXOP with the first STA.

In some embodiments, the first capabilities information is carried in a field in a capabilities element.

In some embodiments, the communications device 1500 is further configured to transmit second capabilities information to the first AP. The second capabilities information is used to indicate whether the first STA can use a TXOP shared by the first AP.

In some embodiments, the second capabilities information is carried in a field in the capabilities element.

In some embodiments, the communications device 1500 is further configured to transmit second information to the first AP. The second information is used to indicate buffer information of the first STA.

In some embodiments, the first AP and the second AP belong to a same VBSS. The first STA transmits the second information to the first AP via the second AP.

In some embodiments, the transmitting the second information to the first AP includes: transmitting the second information to the first AP in response to the first STA receiving first trigger information.

In some embodiments, the first trigger information is carried in a BSRP frame.

In some embodiments, the first trigger information is carried in a trigger frame of a newly added first type.

In some embodiments, the transmitting the second information to the first AP includes: transmitting the second information to the first AP in a case that a first condition is met. The first condition includes one or more of the following: a channel is not detected as busy by physical carrier sensing of the first STA; or a value of an internal network allocation vector of the first STA is 0, and basic network allocation vectors of the first STA that are set by all other device than the first AP are 0.

In some embodiments, the communications device 1500 is further configured to receive third information transmitted by the first AP. The third information is used to indicate that the first AP initiates a TXOP sharing procedure for the first STA.

In some embodiments, the third information is carried in a second field, and the second field being a first value indicates that the first AP initiates the TXOP sharing procedure for the first STA.

In some embodiments, the third information is carried in an MU-RTS TXS trigger frame, and the second field is a triggered TXOP sharing mode subfield.

In some embodiments, the communications device 1500 is further configured to: transmit to the first AP response information to the third information in a case that a second condition is met. The second condition includes one or more of the following: a channel is not detected as busy by physical carrier sensing of the first STA; or a value of an internal network allocation vector of the first STA is 0, and basic network allocation vectors of the first STA that are set by all other devices than the first AP are 0.

In some embodiments, the first AP and the second AP belong to a same ESS.

In some embodiments, the communications device 1500 is further configured to transmit data to the second AP and/or another STA in a TXOP shared by the first AP.

In an optional embodiment, the receiving unit 1510 may be a transceiver 1730. The communications device 1500 may further include a processor 1710 and a memory 1720, which are specifically shown in FIG. 17.

FIG. 16 is a schematic diagram of a structure of a communications device 1600 according to an embodiment of this application. The communications device 1600 is a first AP. The communications device 1600 includes a transmitting unit 1610.

The transmitting unit 1610 is configured to transmit a first field to a first STA. The first field is used to carry first information, and the first information is used to indicate that the first AP shares a part of a TXOP acquired by the first AP with the first STA. The first STA is associated with a second AP, and the first STA is in coverage of signal transmission of the first AP.

In some embodiments, the first AP and the second AP belong to a same VBSS.

In some embodiments, the transmitting unit 1610 is specifically configured to transmit the first field to the first STA via the second AP.

In some embodiments, the first STA is in virtual association with the first AP. In a case that the first STA is in virtual association with the first AP, control information and/or management information can be transmitted between the first AP and the first STA, and data cannot be transmitted between the first AP and the first STA.

In some embodiments, the transmitting unit 1610 is specifically configured to transmit the first field to the first STA by using an AID allocated by the first AP to the first STA.

In some embodiments, in a case that the second AP is in coverage of signal transmission of the first AP and the first AP is in coverage of signal transmission of the second AP, the second AP is in virtual association with the first AP; and in a case that the second AP is in virtual association with the first AP, the first AP and the second AP are allowed to transmit control information and/or management information to each other but are not allowed to transmit data to each other.

In some embodiments, the communications device 1600 is further configured to transmit first capabilities information to the first STA. The first capabilities information is used to indicate whether the first AP can share a TXOP with the first STA.

In some embodiments, the first capabilities information is carried in a field in a capabilities element.

In some embodiments, the communications device 1600 is further configured to receive second capabilities information transmitted by the first STA. The second capabilities information is used to indicate whether the first STA can use a TXOP shared by the first AP.

In some embodiments, the second capabilities information is carried in a field in the capabilities element.

In some embodiments, the communications device 1600 is further configured to receive second information transmitted by the first STA. The second information is used to indicate buffer information of the first STA.

In some embodiments, the first AP and the second AP belong to a same VBSS. The first STA transmits the second information to the first AP via the second AP.

In some embodiments, the receiving the second information includes: receiving the second information in response to the first AP transmitting first trigger information.

In some embodiments, the first trigger information is carried in a BSRP frame.

In some embodiments, the first trigger information is carried in a trigger frame of a newly added first type.

In some embodiments, the receiving the second information transmitted by the first STA includes: in a case that a first condition is met, receiving the second information transmitted by the first STA. The first condition includes one or more of the following: a channel is not detected as busy by physical carrier sensing of the first STA; or a value of an internal network allocation vector of the first STA is 0, and basic network allocation vectors of the first STA that are set by all other device than the first AP are 0.

In some embodiments, the communications device 1600 is further configured to transmit third information to the first STA. The third information is used to indicate that the first AP initiates a TXOP sharing procedure for the first STA.

In some embodiments, the third information is carried in a second field, and the second field being a first value indicates that the first AP initiates the TXOP sharing procedure for the first STA.

In some embodiments, the third information is carried in an MU-RTS TXS trigger frame, and the second field is a triggered TXOP sharing mode subfield.

In some embodiments, the communications device 1600 is further configured to: receive response information to the third information in a case that a second condition is met. The second condition includes one or more of the following: a channel is not detected as busy by physical carrier sensing of the first STA; or a value of an internal network allocation vector of the first STA is 0, and basic network allocation vectors of the first STA that are set by all other device than the first AP are 0.

In some embodiments, the communications device 1600 is further configured to receive TXOP information of the second AP transmitted by the second AP.

In some embodiments, the first AP and the second AP belong to a same VBSS, and the TXOP information of the second AP is transmitted via a multi-AP coordinator in a VBSS.

In some embodiments, the TXOP shared by the first AP with the first STA is outside duration of the TXOP of the second AP.

In some embodiments, the first AP and the second AP belong to a same ESS.

In an optional embodiment, the transmitting unit 1610 may be a transceiver 1730. The communications device 1600 may further include a processor 1710 and a memory 1720, which are specifically shown in FIG. 17.

FIG. 17 is a schematic structural diagram of an apparatus for communication according to an embodiment of this application. Dashed lines in FIG. 17 indicate that a unit or module is optional. The apparatus 1700 may be configured to implement the methods described in the foregoing method embodiments. The apparatus 1700 may be a chip or a communications device.

The apparatus 1700 may include one or more processors 1710. The processor 1710 may support the apparatus 1700 in implementing the methods described in the foregoing method embodiments. The processor 1710 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1700 may further include one or more memories 1720. The memory 1720 stores a program, where the program may be executed by the processor 1710, to cause the processor 1710 to execute the methods described in the method embodiments. The memory 1720 may be separated from or integrated into the processor 1710.

The apparatus 1700 may further include a transceiver 1730. The processor 1710 may communicate with another device or chip by using the transceiver 1730. For example, the processor 1710 may transmit data to and receive data from another device or chip through the transceiver 1730.

An embodiment of this application further provides a computer-readable storage medium for storing a program. The computer-readable storage medium may be applied to a terminal or a network device provided in embodiments of this application, and the program causes a computer to execute the methods executed by the terminal or the network device in various embodiments of this application.

An embodiment of this application further provides a computer program product. The computer program product includes a program. The computer program product may be applied to a terminal or a network device provided in embodiments of this application, and the program causes a computer to execute the methods executed by the terminal or the network device in various embodiments of this application.

An embodiment of this application further provides a computer program. The computer program may be applied to a terminal or a network device provided in embodiments of this application, and the computer program causes a computer to execute the methods executed by the terminal or the network device in various embodiments of this application.

It should be understood that the terms “system” and “network” in this application may be used interchangeably. In addition, the terms used in this application are used only to illustrate specific embodiments of this application, but are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In embodiments of this application, “indication” mentioned herein may refer to a direct indication, or may refer to an indirect indication, or may mean that there is an association relationship. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

In embodiments of this application, “B corresponding to A” means that B is associated with A, and B may be determined based on A. However, it should be further understood that, determining B based on A does not mean determining B based only on A, but instead, B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefining” or “pre-configuring” may be implemented by pre-storing corresponding code, tables, or other forms that may be used to indicate related information in devices (for example, including a terminal device and a network device), and a specific implementation thereof is not limited in this application. For example, being predefined may refer to being defined in a protocol.

In embodiments of this application, the term “and/or” describes merely an association relationship between associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, the “include” may refer to direct inclusion, or may refer to indirect inclusion. Optionally, the term “include” mentioned in embodiments of this application may be replaced with “indicate” or “be used to determine”. For example, A including B may be replaced with that A indicates B, or A is used to determine B.

In embodiments of this application, sequence numbers of the foregoing processes do not mean execution orders. The execution orders of the processes should be determined based on functions and internal logic of the processes, and should not be construed as any limitation on the implementation processes of embodiments of this application.

In embodiments of this application, the “protocol” may refer to a standard protocol in the communications field, and may include, for example, a WiFi protocol, and a related protocol applied to a future WiFi communications system, which is not limited in this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (digital subscriber line, DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid-state drive (solid state disk, SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A wireless communication method, comprising:
receiving, by a first station (STA), a first field transmitted by a first access point (AP),
wherein the first field is used to carry first information, the first information is used to indicate that the first AP shares a part of a transmission opportunity (TXOP) acquired by the first AP with the first STA, the first STA is associated with a second AP, and the first STA is in coverage of signal transmission of the first AP.

2. The method according to claim 1, wherein the first STA is in virtual association with the first AP; and
in a case that the first STA is in virtual association with the first AP, the first AP and the first STA are allowed to transmit control information and/or management information to each other but are not allowed to transmit data to each other.

3. The method according to claim 2, wherein the receiving, by the first STA, the first field transmitted by the first AP comprises:
receiving, by the first STA by using an AID allocated by the first AP to the first STA, the first field transmitted by the first AP.

4. The method according to claim 1, wherein in a case that the second AP is in coverage of signal transmission of the first AP and the first AP is in coverage of signal transmission of the second AP, the second AP is in virtual association with the first AP, and in a case that the second AP is in virtual association with the first AP, the first AP and the second AP are allowed to transmit control information and/or management information to each other but are not allowed to transmit data to each other.

5. The method according to claim 1, wherein the method further comprises:
receiving, by the first STA, first capabilities information transmitted by the first AP,
wherein the first capabilities information is used to indicate whether the first AP is capable of sharing a TXOP with the first STA.

6. The method according to claim 1, wherein the method further comprises:
transmitting, by the first STA, second capabilities information to the first AP,
wherein the second capabilities information is used to indicate whether the first STA is capable of using the TXOP shared by the first AP.

7. The method according to claim 1, wherein the method further comprises:
transmitting, by the first STA, second information to the first AP,
wherein the second information is used to indicate buffer information of the first STA.

8. The method according to claim 7, wherein the first AP and the second AP belong to a same VBSS; and the first STA transmits the second information to the first AP via the second AP.

9. The method according to claim 7, wherein the transmitting, by the first STA, the second information to the first AP comprises:
transmitting, by the first STA, the second information to the first AP in response to the first STA receiving first trigger information, wherein the first trigger information is carried in a buffer status report poll (BSRP) frame.

10. The method according to claim 7, wherein the transmitting, by the first STA, the second information to the first AP comprises:
transmitting, by the first STA, the second information to the first AP in response to the first STA receiving first trigger information, wherein the first trigger information is carried in a trigger frame of a newly added first type.

11. The method according to claim 7, wherein the transmitting, by the first STA, the second information to the first AP comprises:
transmitting, by the first STA, the second information to the first AP in a case that a first condition is met,
wherein the first condition comprises one or more of following:
a channel is not detected as busy by physical carrier sensing of the first STA; or
a value of an internal network allocation vector of the first STA is 0, and basic network allocation vectors of the first STA that are set by all other device than the first AP are 0.

12. The method according to claim 1, wherein the method further comprises:
in the TXOP shared by the first AP, transmitting, by the first STA, data to the second AP and/or another STA.

13. A wireless communication method, comprising:
transmitting, by a first access point (AP), a first field to a first station (STA),
wherein the first field is used to carry first information, the first information is used to indicate that the first AP shares a part of a transmission opportunity (TXOP) acquired by the first AP with the first STA, the first STA is associated with a second AP, and the first STA is in coverage of signal transmission of the first AP.

14. The method according to claim 13, wherein the method further comprises:
transmitting, by the first AP, third information to the first STA,
wherein the third information is used to indicate that the first AP initiates a TXOP sharing procedure for the first STA.

15. The method according to claim 14, wherein the third information is carried in a second field, and the second field being a first value indicates that the first AP initiates the TXOP sharing procedure for the first STA.

16. The method according to claim 15, wherein the third information is carried in a multi-user request to send transmission opportunity sharing (MU-RTS TXS) trigger frame, and the second field is a triggered TXOP sharing mode subfield.

17. The method according to claim 14, wherein the method further comprises:
receiving, by the first AP, response information to the third information in a case that a second condition is met,
wherein the second condition comprises one or more of following:
a channel is not detected as busy by physical carrier sensing of the first STA; or
a value of an internal network allocation vector of the first STA is 0, and basic network allocation vectors of the first STA that are set by all other device than the first AP are 0.

18. The method according to claim 13, wherein the first AP and the second AP belong to a same extended service set (ESS).

19. A station (STA), wherein the station is a first STA and comprises a memory and a processor, wherein the memory is configured to store a program, and the processor is configured to invoke the program in the memory to cause the first STA to:
receive a first field transmitted by a first access point (AP),
wherein the first field is used to carry first information, the first information is used to indicate that the first AP shares a part of a transmission opportunity (TXOP) acquired by the first AP with the first STA, the first STA is associated with a second AP, and the first STA is in coverage of signal transmission of the first AP.

20. An access point (AP), wherein the AP is a first AP and comprises a memory and a processor, wherein the memory is configured to store a program, and the processor is configured to invoke the program in the memory to cause the first AP to execute the method according to claim 13.
